(19) United States
(12) Patent Application Publication
(10) Pub. No.: US 2026/0258685 A1
(43) Pub. Date: Sep. 3, 2026

(54) HINGE ASSEMBLY

(71) Applicant: Izzeddin J A HASSAN, Amman (JO)

(72) Inventor: Izzeddin J A HASSAN, Amman (JO)

(21) Appl. No.: 18/580,970

(22) PCT Filed: Nov. 2, 2023
(86) PCT No.: PCT/IB2023/061025

§ 371 Date: Jan. 19, 2024

(51) Int. Cl. E05D 11/06; E05D 7/04

(52) U.S. Cl. CPC E05D 11/06; E05D 7/0407; E05Y 2201/682; E05Y 2201/696; E05Y 2600/12; E05Y 2600/58; E05Y 2900/20

(57) ABSTRACT

A hinge assembly (100) comprising a primary hinge base (102) connected to a supporting base (1010), a hinge cup (107) connected to a door (202), a door gap stability component (106) connected between the primary hinge base (102) and the hinge cup (107) and a door opening angle controller (108) connected between the hinge cup (107) and the door gap stability component (106). The door gap stability component (106) is configured to perform left-right adjustments and concurrent in-out adjustments in response to the left-right adjustments of the door (202) relative to the supporting base (1010) ensuring a uniform gap between the door (202) and its supporting base (1010). The door opening angle controller (108) is adapted to control the opening or closing angle of the door (202) within a predetermined range.

### FIELD OF THE INVENTION

Embodiments of the present invention generally relate to door closure systems. Particularly, present disclosure relates to a hinge assembly that offers stability, user-centric control, and overall enhancement in door operation.

### BACKGROUND OF THE INVENTION

Doors and cabinets, common components of everyday infrastructure, have traditionally been operated using rudimentary hinge systems. These hinge systems, while foundational for pivoting movements, often failed to deliver a refined user experience. The prevalent issues included doors sagging, misaligning after frequent usage, or failing to close softly, causing loud disturbances.

Furthermore, with evolving architectural designs and growing consumer demand for enhanced user-centric control, traditional hinge systems became quickly outdated. While they were successful in their primary function, they lacked in finesse, precision, stability, and adaptive control. Such inherent limitations led to inefficient operations, regular maintenance requirements, and potential wear and tear over time.

The hinge technology also traditionally struggled with issues like abrupt door closures, inconsistent gaps between doors and their frames, and even the annoyance of squeaky sounds, indicating friction between components and a need for lubrication.

In the recent past, innovative attempts were made to integrate features like soft-close dampers, which, although effective, were limited in their capacity to provide a holistic solution. Additionally, while some modern hinge systems did adopt self-lubrication mechanisms to reduce maintenance intervals and ensure smoother operations, they lacked the adaptability to changing usage patterns.

Moreover, traditional hinge designs also lacked modular architecture, making upgrades or component replacements a challenging task. As a result, if one part of the hinge system malfunctioned or needed an upgrade, often, the entire hinge assembly had to be replaced.

Accordingly, there remains a need in the art for a hinge assembly system that can overcome the aforementioned problems and also integrates enhanced features such as user-centric control, adaptive lubrication, modular components, and safety mechanisms to prevent jamming or pinching.

### OBJECT OF THE INVENTION

An object of the present invention is to provide a hinge assembly that offers enhanced stability, user-centric control, and efficient door operation.

Another object of the present invention is to provide an assembly with corrosion-resistant, high-strength to ensure long-lasting performance and smooth functionality even in demanding environments.

Yet another object of the present invention is to introduce a door opening angle controller that allows users to specify predetermined door opening angle.

Yet another object of the present invention is to introduce a door opening angle controller that allows users to specify granting unparalleled control over door positioning.

Yet another object of the present invention is to incorporate an adjustable locking mechanism within the door opening angle controller, facilitating the efficient and secure specification of various door angles based on user preferences.

Yet another object of the present invention is to offer an advanced hinge assembly that incorporates an integrated lubrication system, dispensing lubrication based on usage patterns, thereby ensuring prolonged lifespan and smooth functionality.

Yet another object of the present invention is to design a hinge system where components, such as the soft-close damper, are easily detachable and interchangeable, granting users the flexibility to upgrade or modify specific features without the need for a complete hinge replacement.

### SUMMARY OF THE INVENTION

According to a first aspect of the present invention, there is provided a hinge assembly system. The assembly comprises a primary hinge base connected to a supporting base, a hinge cup connected to a door, a door gap stability component, and a door opening angle controller connected between the hinge cup and the door gap stability component. The door gap stability component is adapted to make adjustments to the door with respect to its supporting base, and the door opening angle controller controls the opening or closing angle of the door within a predetermined range.

In accordance with an embodiment of the present invention, wherein the door gap stability component includes one or more adjustable screws, one or more directional pins within the one or more directional slots, an upper hinge arm, a middle hinge arm and a lower hinge arm.

In accordance with an embodiment of the present invention, wherein the door gap stability component includes adjustable components like screws and pins which aid in guiding and adjusting the movements of the door, ensuring a uniform gap between the door and its supporting base.

In accordance with an embodiment of the present invention, wherein the door opening angle controller includes an adjustment button with one or more adjustable punched paths.

In accordance with an embodiment of the present invention, wherein the door opening angle controller is adapted to slide into the one or more adjustable punched paths to control the opening angle of the door to a predetermined range.

In accordance with an embodiment of the present invention, wherein the door opening angle controller, comprising an adjustment button and adjustable paths, facilitates control of the opening angle of the door within specified ranges such as between 80 to 120 degrees.

In accordance with an embodiment of the present invention, wherein the hinge assembly comes with a universal mounting plate, making it suitable for installation on various surfaces.

In accordance with an embodiment of the present invention, wherein the hinge assembly is adjustable for both height-depth and left-or right-handed doors.

In accordance with an embodiment of the present invention, wherein the one or more adjustable screws are assisted by thread-locking, preventing unintentional loosening over time.

In accordance with an embodiment of the present invention, wherein the door opening angle controller is enhanced with engraved markings, aiding users in visually setting specific opening angles.

### BRIEF DESCRIPTION OF THE DRAWINGS

So that the manner in which the above recited features of the present invention can be understood in detail, a more particular to the description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, the invention may admit to other equally effective embodiments. These and other features, benefits and advantages of the present invention will become apparent by reference to the following text figure, with like reference numbers referring to like structures across the views, wherein:

FIG. 1A illustrates a hinge assembly with a door gap stability component, in accordance with an embodiment of the present invention;

FIG. 1B illustrates an exploded view of the hinge assembly with a door gap stability component, in accordance with an embodiment of the present invention;

FIG. 2A-2B illustrates an adjustable screw arrangement for uniform gap in the door gap stability component, in accordance with an embodiment of the present invention;

FIG. 3A illustrates a door opening angle controller of the hinge assembly, in accordance with the present invention;

FIG. 3B illustrates side view of the door opening angle controller, in accordance with the present invention; and

FIG. 4A-4C illustrates an operation of the door opening angle controller operating at predetermined angles, in accordance with the present invention.

### DETAILED DESCRIPTION OF THE DRAWINGS

The present invention is described hereinafter by various embodiments with reference to the accompanying drawing, wherein reference numerals used in the accompanying drawing correspond to the like elements throughout the description.

While the present invention is described herein by way of example using embodiments and illustrative drawings, those skilled in the art will recognize that the invention is not limited to the embodiments of drawing or drawings described and are not intended to represent the scale of the various components. Further, some components that may form a part of the invention may not be illustrated in certain figures, for ease of illustration, and such omissions do not limit the embodiments outlined in any way. It should be understood that the drawings and detailed description thereto are not intended to limit the invention to the particular form disclosed, but on the contrary, the invention is to cover all modifications, equivalents, and alternatives falling within the scope of the present invention as defined by the appended claims. As used throughout this description, the word “may” is used in a permissive sense (i.e., meaning having the potential to), rather than the mandatory sense, (i.e., meaning must). Further, the words “a” or “an” mean “at least one” and the word “plurality” means “one or more” unless otherwise mentioned. Furthermore, the terminology and phraseology used herein is solely used for descriptive purposes and should not be construed as limiting in scope. Language such as “including,” “comprising,” “having,” “containing,” or “involving,” and variations thereof, is intended to be broad and encompass the subject matter listed thereafter, equivalents, and additional subject matter not recited, and is not intended to exclude other additives, components, integers or steps. Likewise, the term “comprising” is considered synonymous with the terms “including” or “containing” for applicable legal purposes. Any discussion of documents, acts, materials, devices, articles and the like is included in the specification solely for the purpose of providing a context for the present invention. It is not suggested or represented that any or all of these matters form part of the prior art base or were common general knowledge in the field relevant to the present invention.

This invention may, however, be embodied in many different forms and should not be construed as limited to the embodiment set forth herein. Rather, the embodiment is provided so that this disclosure will be thorough and complete and will fully convey the scope of the invention to those skilled in the art. In the following detailed description, numeric values and ranges are provided for various aspects of the implementations described. These values and ranges are to be treated as examples only and are not intended to limit the scope of the claims. In addition, a number of materials are identified as suitable for various facets of the implementations. These materials are to be treated as exemplary and are not intended to limit the scope of the invention.

The present invention aims to revolutionize traditional door hinge systems, addressing prevalent challenges like door misalignment or sagging with respect to the base, abrupt closures, and maintenance issues. The hinge assembly in the present invention is configured to enhance stability, user-centric control, and improved door operations.

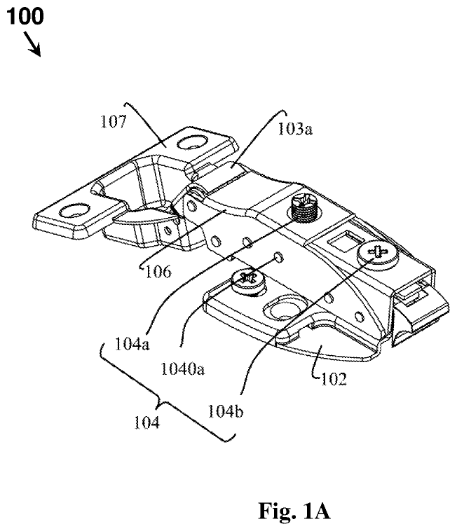

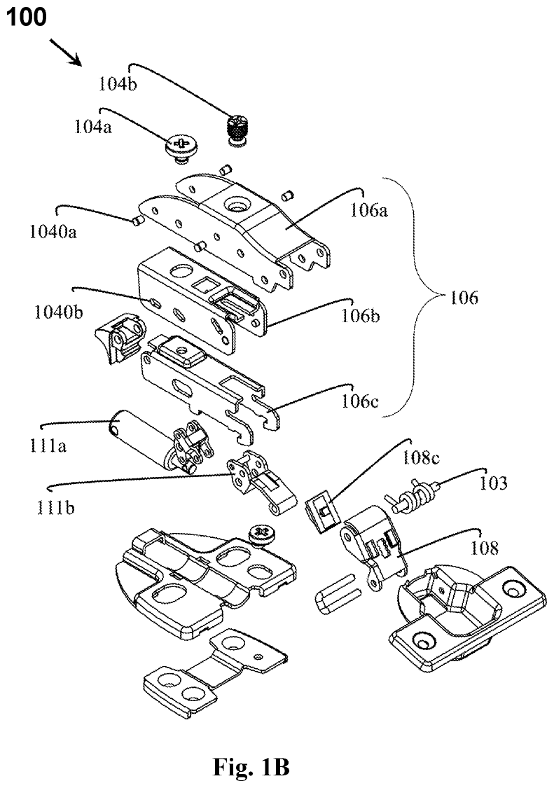

FIG. 1A illustrates a hinge assembly, in accordance with an embodiment of the present invention. As shown in FIG. 1A, the hinge assembly (100) comprises, but not limited to, a primary hinge base (102), a hinge arm (106), a hinge cup (107), one or more adjustable screws (104a, 104b), a hinge link (103a) with a hinge pin and a door gap stability component (106).

The primary hinge base (102) of hinge assembly (100) is operably connected to a supporting base (such as door frame, cabinet frame etc.) at one end while connected to a door through the hinge cup (107) at the other end. Further, the hinge cup (107) is attached to a door (202) through the door connecting bracket or door gap stability component (106) at the opposing end. Herein, the primary hinge base (102), the hinge cup (107), and the door gap stability component (106) are connected though one or more connectors (104). The materials selected for the primary hinge base (102) may be, but not limited to, Stainless Steel, Zirconium, Monel, Bronze, Brass Inconel, Aluminum Alloys, Nickel and Nickel Alloys. It ensures durability and resistance to corrosion.

The one or more connectors (104) may be selected from, but not limited to, screws, rivets, pins, welding or combination thereof. The materials selected for the one or more connectors (104)) may be, but not limited to, Stainless Steel, Zirconium, Monel, Bronze, Brass Inconel, Aluminum Alloys, Nickel and Nickel Alloys. It ensures durability and resistance to corrosion.

The hinge pin may be understood as a strong metal cylindrical rod that is configured to rotate the hinge cup (107). The door gap stability component (106) includes one or more adjustable screws (104a-104b) and is configured to adjust the in-out and left-right movements of the door. In some embodiments, the primary hinge base (102) and a hinge cup (107) may be equipped with a universal mounting plate (not shown) for easy installation on a variety of surfaces. The materials selected for the hinge cup (107) and the hinge pin may be, but not limited to, Stainless Steel, Zirconium, Monel, Bronze, Brass Inconel, Aluminum Alloys, Nickel and Nickel Alloys. It ensures durability and resistance to corrosion.

FIG. 1B illustrates an exploded view of the hinge assembly with a door gap stability component, in accordance with an embodiment of the present invention. The FIG. 1B, illustrates a more detailed view revealing components of the hinge assembly (100). The hinge arms (106) include an upper hinge arm (106a) with a directional pin (1040a), and middle hinge arm (106b) with one or more directional guide slots (1040b), and lower hinge arm (106c). The materials selected for the hinge arm (106) may be, but not limited to, Stainless Steel, Zirconium, Monel, Bronze, Brass Inconel, Aluminum Alloys, Nickel and Nickel Alloys. It ensures durability and resistance to corrosion.

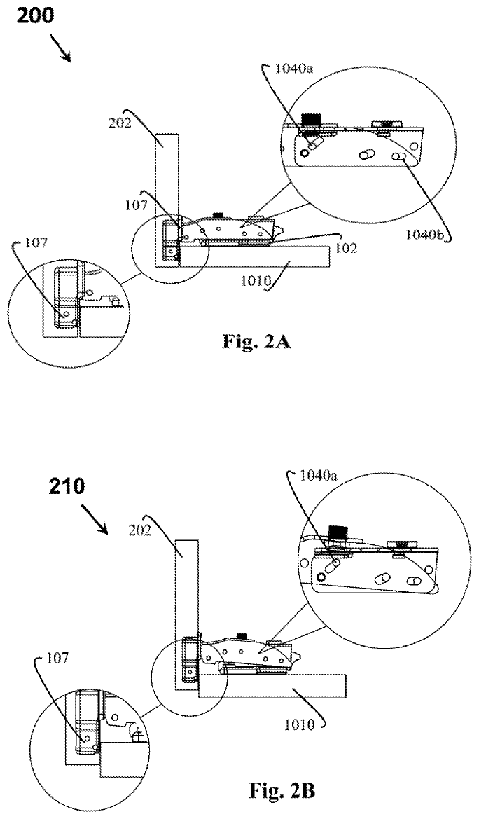

The one or more adjustable screws (104a, 104b) includes one or more left and right adjustment screws (104a) and in and out adjustment screws (104b). These one or more adjustable screws (104a, 104b) are configured to make left-right and in-out adjustment of the door (202) with respect to the supporting base (1010). Further, one or more directional pins (1040a) are configured within one or more directional guide slots (1040b) and adjusted to guide the upper hinge arm (1060a) as shown in FIGS. 2A and 2B.

The hinge pin (103) may be placed between the hinge cup (107) and the door gap stability component (106) with a spring or restoring mechanism. The spring or restoring mechanism not only ensures a controlled return to the initial stance but also provides resistance against unwanted movements, offering functionalities like a “soft close” or “soft open” to the door, preventing abrupt actions and promoting smooth operations. The hinge pin (103) may be covered with the hinge pin cover. The material for the hinge pin (103) may be selected from, but not limited to nylon, bronze, brass, Teflon, stainless steel, or aluminum, to reduce friction, lessen wear, and securely hold the hinge in place.

Furthermore, the hinge assembly (100) further include a door opening angle controller (108), an adjustment button (108b) with one or more adjustable punched paths (108a), an opening angle restrictor (108c), a suspension system. Wherein, the suspension system comprises a hydraulic piston (111a), hydraulic piston connection part (111b) under the lower hinge arm (106c).

FIG. 2A-2B illustrates an adjustable screw arrangement for uniform gap in the door gap stability component, in accordance with an embodiment of the present invention. As shown in FIG. 2A-2B, the hinge assembly (100) is securely anchored to a foundational platform or supporting base (1010) via the hinge base (102) at one end and the hinge cup (107) is attached to a door (202) through the door connecting bracket or door gap stability component (106) at the opposing end. The connections between the hinge base (102) and the door gap stability component (106) are established through the integration of the lower hinge arm (106c) with the hinge base (102).

As depicted in FIG. 2A, the one or more directional pin (1040a) may be configured to move either left to right or up or down within the directional guide slots (1040b). The movement of the one or more directional pin (1040a) may result in increase or restrict left to right movement range of the door or flap (202) relative to the frame or cupboard (1010). Similarly depicted in FIG. 2B, the hinge assembly (100), the one or more directional pin (1040a) may be configured to move either left to right or up or down within the directional guide slots (1040b). The movement of the one or more directional pin (1040a) may result in increase or restrict in and out movement range of the door or flap (202) relative to the frame or cupboard (1010).

The foundational platform or a supporting base (1010) may be selected from, but not limited to, a door, a frame etc. Herein, the door (202) at the hinge cup (107) may be understood as a flap, or a frame supported glass or a surface that is movable around the hinge pin (103).

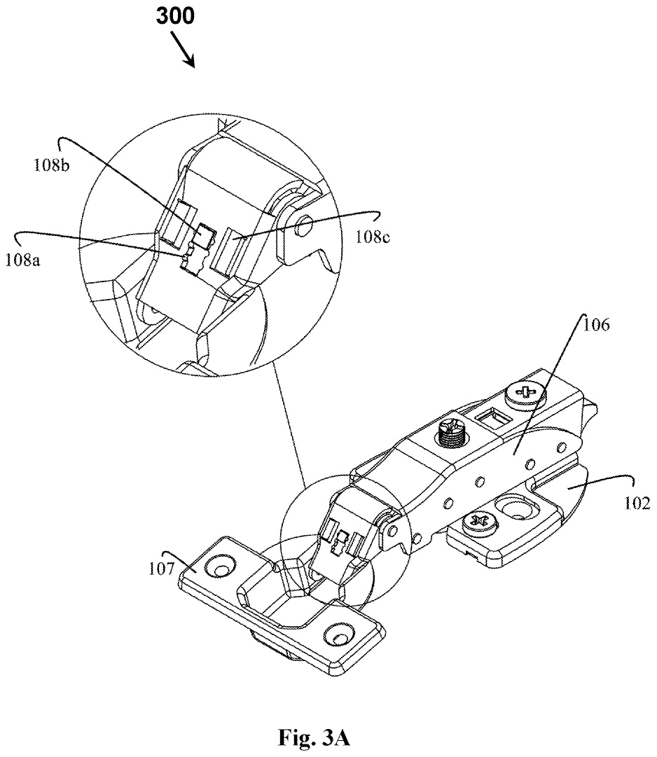

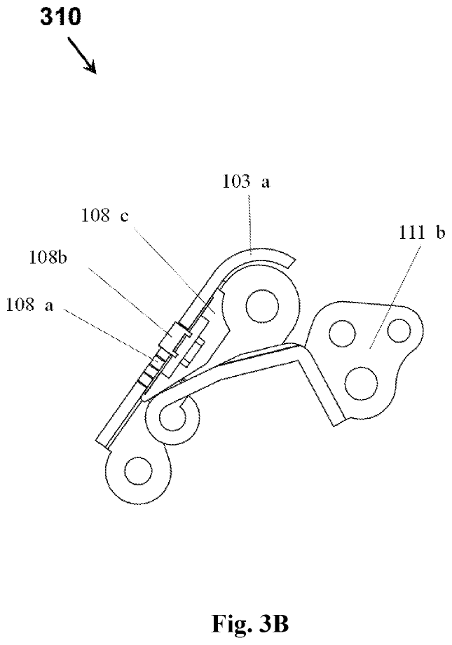

FIG. 3A illustrates a door opening angle controller of the hinge assembly, in accordance with the present invention. As shown in FIG. 3A, the hinge assembly (100) includes a door opening angle controller (108) operationally connected to the hinge cup (107), and the door connecting bracket or door gap stability component (106).

FIG. 3B illustrates side view of the door opening angle controller, in accordance with the present invention. As shown in the FIG. 3B the door opening angle controller (108) includes an opening Angle Restrictor (108c), an adjustment button (108b) with punched adjustable path (108a).

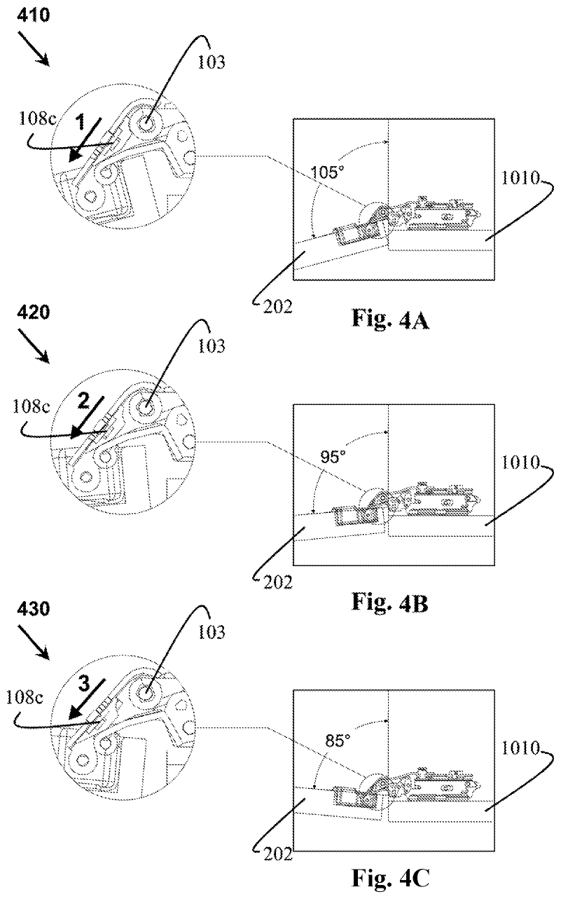

FIG. 4A-4C illustrates an operation of the door opening angle controller operating at predetermined angles, in accordance with the present invention. As shown in the FIG. 4A-4C the door opening angle controller (108) may be adjusted to predetermined angles or predetermined range selected from a range of, but not limited to, 80 to 120 degrees. In opening angle control, the adjustment button (108b) is adapted to slide into the adjustable path (108a) and accordingly, the sliding motion is controlled within the adjustable path (108a). It may control or restrict the opening angle of the door. The hydraulic piston connection part (111b) is configured to complement the function of opening Angle Restrictor (108c). The door opening angle controller (108) is adapted to control the opening or closing angle of the door (202) within a predetermined range.

In some embodiments, the door opening angle controller (108) may be adjusted to one or more distinct positions, as exemplified in the embodiments (410-430) in FIG. 4A-4C, with predetermined angles set at 85, 95, and 105 degrees. In FIG. 4A the door opening angle controller (108) is configured for angular movement (referred as setting 2) ranging from 0 to 105 degree between the door (202) and the supporting base (1010).

In FIG. 4B the door opening angle controller (108) is configured for angular movement (referred as setting 2) ranging from 0 to 95 degree between the door (202) and the supporting base (1010). In FIG. 4C the door opening angle controller (108) is configured for angular movement (referred as setting 3) ranging from 0 to 85 degree between the door (202) and the supporting base (1010). It ensures consistent and controlled door opening angles for user convenience and safety. The door opening angle controller (108) in some embodiment may act as a protective mechanism, minimizing over-extensions that might lead to obstructions or damages. The door opening angle controller (108) is not merely a static component but boasts an adjustable locking mechanism allowing users to specify varied door angles according to individual preferences.

The materials selected for the hinge assembly (100) may be, but not limited to, Stainless Steel, Zirconium, Monel, Bronze, Brass Inconel, Aluminum Alloys, Nickel and Nickel Alloys. It ensures durability and resistance to corrosion.

In order to understand the method of operation of the present invention (100) consider an exemplary embodiment, as shown in FIG. 1 and FIGS. 2A-2B. The hinge assembly (100) is configured to facilitate the rotation of objects like door or window frame (202) about the wall or supporting base (1010) around a predefined axis along the hinge pin (103). During the motion of opening or closing as shown in FIG. 2A-2B, the door (202) may be governed by the rotary movement of the hinge pin (103) inside the protective sleeve like structure placed between the hinge cup (107) and the door gap stability component (106), ensuring the gentle swing of the door, cupboard or window (202). The door gap stability component (106), integrated on the primary hinge base (102), uses adjustable screws (104) to maintain a consistent gap between the supporting base (1010) and its frame or cabinet (202) as illustrated by FIG. 2A (normal position) and FIG. 2B (with a gap). In an up-down connection, the hinge assembly (100) maintains a vertical alignment, while in a left-right connection, it ensures the horizontal stability of the door (202). The door gap stability component (106) configured to perform left-right adjustments and concurrent in-out adjustments in response to the left-right adjustments of the door (202) relative to the supporting base (1010) ensuring a uniform gap between the door (202) and its supporting base (1010). The method may reduce the need for regular maintenance and increases the lifespan of the door-hinge assembly system.

In some embodiments of present invention, the hinge assemble (100) may be adapted to accommodate one or more soft-close dampers (not shown) that may avoid extra suspension for smooth or soft opening and closing of the doors (202). The soft-close damper is a component configured to ensure that doors or drawers (202) close smoothly and silently. It includes a robust housing and a piston which operates using either a viscous liquid or a spring mechanism. As a door (202) closes, the piston movement creates resistance, either by pushing against the viscous liquid or by spring tension, ensuring a smooth and silent closure. The material for the housing may be selected from but not limited to Polycarbonate (PC), Polyoxymethylene (POM) or Acetal, Aluminum, Stainless steel, Zinc alloy or ABS (Acrylonitrile Butadiene Styrene). Whereas the material for the piston may be selected from but not limited to Polyurethane (PU), Polyethylene (PE), PTFE (Polytetrafluoroethylene or Teflon), Brass, Anodized aluminum or Stainless steel.

In some embodiments of present invention, the hinge assemble (100) may be adapted to accommodate a self-lubrication unit (not shown). It autonomously dispenses lubrication depending on usage patterns. The self-lubrication unit, comprises a reservoir for lubricant storage, which, depending on its application, can differ in shape. A porous medium, such as sintered bronze or porous polymers, allows the lubricant or viscous liquid to flow gradually. The porous material possesses interconnected pores that function akin to capillary tubes, facilitating lubricant distribution through capillary action. The lubricant, chosen from substances like, but not limited to, oil or grease, diminishes friction between components. One or more seals or O-rings may be used to ensure the containment and protection of lubricant from contaminants. Optionally a spring may be used to further regulate lubricant release. This self-lubrication ensures the hinge's consistent smooth operation and longevity, reducing maintenance needs.

The hinge assembly (100) forms a pivotal bridge between the entrance door (202) and the door frame (1010). Serving as an intermediary, it permits the door to slowly swing open or close while remaining anchored firmly to the frame. On the other hand, the door frame, usually made from similar materials, provides the essential structural support. Embedded within this hinge assembly is the ingenious door opening angle controller (108), which plays a crucial role in dictating the door's movement. Made from durable metals like stainless steel or aluminum, the component ensures the swing angle of the door remains flexible between 80 to 120 degrees. An integral part of the door opening angle controller (108) is the adjustment button (108b), possibly crafted from durable plastics or aluminum, which allows users to easily modify the door's swing angle. The adjustment button (108b) moves along paths called adjustable punched paths (108a). These paths are usually made from strong metals like stainless steel or brass because they need to be precise and long-lasting. The opening angle restrictor (108c) and the hydraulic piston connection part (111b) work in unison to safeguard against potential over-extensions of the door. While the restrictor, made of robust metals such as steel or aluminum, sets a protective boundary, the hydraulic piston, constructed from pressure-resistant materials like stainless steel, ensures the door's motion remains smooth and consistent. Overall, the deliberate design and synchronization of each component within the hinge assembly not only enhance the functionality but also heighten user convenience, safety, and the overall aesthetic appeal of the space.

For example, if a user decided to renovate their kitchen, they wanted their kitchen cabinet doors to operate smoothly with a uniform gap, a soft-close mechanism, and adjustable door opening angles. To meet these requirements, the hinge assembly (100) of the present invention may be used. The installation may begin with the attachment of the primary hinge base (102) to the cabinet frame. The hinge cup (107) may be then connected to the door via the door gap stability component (106). These components may be connected using one or more connects such as screws (1040). For easy future adjustments, the adjustable screws (104a, 104b) were incorporated. After installing the door, a slight misalignment in the gap may be noticed. The misalignment may be rectified by tweaking the adjustable screw (104a), and the directional pins (1040a) within the directional guide slots (1040b), ensured a perfectly consistent door-to-cabinet gap. To enhance the user experience and prevent door slamming, a soft-close damper with suspension system may be integrated. The damper may ensure the door closed smoothly and silently. The user's preference of a 95-degree maximum door opening may be achieved through the door opening angle controller (108). The setting may be achieved by using the opening angle retractor and the

The hinge assembly also boasted a self-lubrication unit, ensuring long-lasting smooth operation without the need for manual lubrication. Upon testing, the user found the door maintained an appealing consistent gap with the cabinet. The soft-close damper ensured that even swift closures resulted in a gentle and silent shut. The door's movement was restricted beyond their desired 95 degrees, and over several days, its operation remained seamless and free from wear or noise, thanks to the self-lubricating mechanism. Overall, the user was thoroughly satisfied with the hinge assembly's performance, deeming it a pivotal part of their successful kitchen renovation.

Similarly, if a user decided to upgrade the entrance doors to enhance functionality and aesthetics. The user selected the innovative hinge assembly (100) to connect the entrance door (202) with the door frame (1010). Once installed, the entrance door (202) displayed a significantly improved alignment with the door frame (1010). As the door swung open, it revealed one of the hinge assembly's most notable features: the door opening angle controller (108). The assembly, detailed in FIGS. 4A-4C, allowed the door's opening angle to be precisely adjusted. The user was offered a range, notably between 80 to 120 degrees, to define the extent of the door's swing.

When the user desired a broader entrance, they adjusted the door opening angle controller (108) to enable an angular movement of up to 105 degrees between the entrance door (202) and the door frame (1010), as depicted in FIG. 4A. However, when space constraints demanded a narrower swing, the angle was reduced to 95 degrees, as illustrated in FIG. 4B. For tighter spaces or to prevent potential collisions with adjacent walls, the angle was set to a more restricted 85 degrees, showcased in FIG. 4C.

The hinge assembly's advanced design provided consistent and controlled door opening angles, catering to both safety and convenience. Additionally, the door opening angle controller (108) acted as a protective measure, ensuring the door didn't over-extend, preventing obstructions or damage. With the ability to lock the door angle as per individual preferences, the user felt an enhanced sense of control over their living space, making the hinge assembly (100) a valued addition to their apartment entrance.

Consider a scenario where a user has a double-door system, with each door hinged on opposing sides of a common frame. The hinge assembly in this case is placed between these two doors, enabling them to move independently but with synchronized precision. Each door is equipped with its own primary hinge base (102) which is attached to the supporting base (1010).

As the user approaches to open the first door, the primary hinge base (102) on this door engages, pivoting smoothly. Since the primary hinge base (102) is attached to the supporting base (1010), the door's movement is controlled and fluid. The hydraulic piston connection (111) ensures that the door doesn't slam shut or swing too quickly. The hydraulic piston connection part (111b) plays a role in augmenting the functioning of the opening Angle Restrictor (108c).

Now, when the user proceeds to the second door, the process is repeated. The primary hinge base (102) on the second door engages, and as this is attached to the supporting base (1010), the door swings open with the same controlled motion as the first. The door opening angle controller (108) on both doors ensures that they open to a user-set predetermined angle, which could be anywhere from 80 to 120 degrees, based on the user's preference.

This dual-door system with the hinge assembly provides the user with the flexibility of opening one or both doors. The door opening angle controller (108) ensures safety, preventing any unintended wide swings, which might be a hazard in tight spaces or where there are obstructions. As seen from the above description, the hinge assembly (100) invention effectively addresses several key objectives critical for modern door installations. Emphasizing stability in some embodiment, It may also use other durable materials in its assembly, including features such as, but not limited to adjustable locking mechanism, ensuring reliable door operation and precise control. For durability, the assembly may employ materials known for their resistance to corrosion, ensuring longevity even in challenging environments. In terms of user experience, the door opening angle controller may allow users to set specific door angles. It may include the lubrication system, that may be adjusted based on usage patterns, ensuring consistent performance over time.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to be providing broadest scope of consistent with the principles and the novel and inventive features disclosed or suggested herein. Accordingly, the invention is anticipated to hold on to all other such alternatives, modifications, and variations that fall within the scope of the present invention and the appended claims.

1. A hinge assembly (100) comprises:
a primary hinge base (102) operationally connected to a supporting base (1010);
a hinge cup (107) operationally connected to a door (202);
a door gap stability component (106) operationally connected between the primary hinge base (102) and the hinge cup (107); and
a door opening angle controller (108) operationally connected between the hinge cup (107) and the door gap stability component (106);
wherein the door gap stability component (106) is configured to perform left-right adjustments and concurrent in-out adjustments in response to the left-right adjustments of the door (202) relative to the supporting base (1010) ensuring a uniform gap between the door (202) and its supporting base (1010);
wherein the door opening angle controller (108) is adapted to control the opening or closing angle of the door (202) within a predetermined range.

2. The hinge assembly (100) of claim 1, wherein the door gap stability component (106) includes one or more adjustable screws (104a, 104b), one or more directional pins (1040a) within the one or more directional slots (1040b), an upper hinge arm (106a), a middle hinge arm (106b), and a lower hinge arm (106c).

3. The hinge assembly (100) of claim 1, wherein the one or more adjustable screws (104a,104b), disposed on the surface of the upper hinge arm (106a), is configured to adjust the in-out and left-right movements of the door (202) ensuring a uniform gap between the door (202) and its supporting base (1010).

4. The hinge assembly (100) of claim 1, wherein the one or more directional pins (1040a) are configured to move within the one or more directional slots (1040b) on the upper hinge arm (106a) ensuring proper guidance of the upper hinge arm (106a).

5. The hinge assembly (100) of claim 1, wherein the door opening angle controller (108) includes an adjustment button (108b) with one or more adjustable punched paths (108a).

6. The hinge assembly (100) of claim 1, wherein the door opening angle controller (108) is adapted to slide into the one or more adjustable punched paths (108a) to control the opening angle of the door (202) to a predetermined range.

7. The hinge assembly (100) of claim 1, wherein the predetermined range opening or closing angle of the door (202) is between 80 to 120 degrees.

8. The hinge assembly (100) of claim 1, wherein the hinge assembly (100) is equipped with a universal mounting plate for easy installation on a variety of surfaces.

9. The hinge assembly (100) of claim 1, wherein the hinge assembly (100) is adjustable for both height—depth and left- or right-handed doors (202).

10. The hinge assembly (100) of claim 1, wherein the one or more adjustable screws (104a, 104b) are assisted by thread-locking, preventing unintentional loosening over time.

11. The hinge assembly (100) of claim 1, wherein the door opening angle controller (108) is complemented with engraved degree markings, offering visual guidance for setting specific opening angles.
